(19) United States
(12) Patent Application Publication
(10) Pub. No.: US 2015/0038213 A1
(43) Pub. Date: Feb. 5, 2015

(54) ELECTRONIC GAMING MACHINE AND METHOD

(71) Applicant: AINSWORTH GAME TECHNOLOGY LIMITED, Newington (AU)

(72) Inventor: Jason Meyer, Abbotsford (AU)

(21) Appl. No.: 14/444,269

(22) Filed: Jul. 28, 2014

(30) Foreign Application Priority Data
Jul. 30, 2013 (AU) 2013902832
Nov. 29, 2013 (AU) 2013904628

(51) Int. Cl. G07F 17/32; G07F 17/34

(52) U.S. Cl. CPC G07F 17/3213; G07F 17/34
USPC 463/20

(57) ABSTRACT

An electronic gaming machine includes a display for displaying a game and an electronic game controller for controlling the display of game symbols for the game on the display. The game includes game symbols arranged into an array of predetermined symbol positions to define a plurality of reels. The electronic game controller causes the game symbols in a first of the reels to visually move in a linear path on the display and the game symbols in a second of the reels to visually move in a non-linear path on the display.

### BACKGROUND

The present invention relates to an electronic gaming machine and in a particular an electronic gaming machine having a base game and a feature game. The invention has been developed primarily for use as an electronic gaming machine and will be described hereinafter by reference to this application

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, computational processor or other central processing unit, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

It is an object of the invention in at least one preferred form to provide an electronic gaming machine and a gaming method for an electronic gaming machine that encourages player interest.

### SUMMARY

According to a first aspect of the present invention, there is provided an electronic gaming machine comprising:

a display for displaying a game, wherein said game comprises said game symbols arranged into an array of predetermined symbol positions to define a plurality of reels and where predetermined winning combinations of randomly selected game symbols in said game award prizes to a player, and

an electronic game controller for controlling the display of game symbols for said game on said display,

wherein said electronic game controller causes said game symbols in a first of said reels to visually move in a linear path on said display and said game symbols in a second of said reels to visually move in a non-linear path on said display.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Preferably, said electronic game controller causes said second reel to be displayed as having an arcuate or curved shape in the horizontal plane of said display so that said game symbols visually move in an arcuate or curved path in said second reel.

Preferably, at least one game symbol appearing in one of said first reel and said second reel interacts with the game symbols appearing in the other of said first reel and said second reel. More preferably, said at least one game symbol comprises a special game symbol.

Preferably, there is a plurality of said first reels and said predetermined symbol positions in said second reel are respectively associated with said first reels. More preferably, a first special game symbol appearing in one of said predetermined symbol positions of said second reel causes said game symbols in the associated first reel to change into another game symbol. In one preferred form, said game symbols in the associated first reel change into at least one of said special game symbol and a substitute symbol.

Preferably, said electronic game controller causes second reel to spin in response to a trigger event in said first reels. More preferably, said trigger event comprises the appearance of a trigger symbol in one of said first reels.

Preferably, said game comprises a base game and a feature game, said base game comprising said first reels and said second reel, and said electronic game controller causes an additional second reel to be displayed with said first reels and said second reel in said feature game, and wherein said predetermined symbol positions in said additional second reel are respectively associated with said predetermined positions of said second reel. More preferably, a second special game symbol appearing in one of said predetermined symbol positions of said second reel causes said additional second reel to spin. In one preferred form, the appearance of a game enhancing symbol in the predetermined symbol position of said additional second reel associated with the predetermined symbol position of said second reel displaying said second special game symbol causes the award of a game enhancing element associated with said game enhancing symbol.

Preferably, said feature game comprises a further second reel, said predetermined symbol positions in said further second reel are respectively associated with said predetermined positions of said additional second reel. More preferably, a third special game symbol appearing in one of said predetermined symbol positions of said additional second reel causes said further second reel to spin. In one preferred form, the appearance of a game enhancing symbol in the predetermined symbol position of said further second reel associated with the predetermined symbol position of said additional second reel displaying said third special game symbol causes the award of a game enhancing element associated with said game enhancing symbol. In one preferred form, said game enhancing symbol comprises a jackpot symbol and said game enhancing element comprises a jackpot prize. In a particularly preferred form, said predetermined symbol positions of said further second reel are associated with separate jackpot prizes.

Preferably, the probability of said third special symbol appearing in said in one of said predetermined symbol positions of said additional second reel depends on the value or amount of a bet made to play said base game. More preferably, the frequency of said third special symbols appearing on said additional second reel increases as the value or amount of said bet increases

Preferably, the type of game enhancing symbols available for display on said additional second reel depend on the value or amount of a bet made to play said base game. More preferably, game enhancing symbols awarding game enhancing elements of higher value become available for higher value or amounts of said bet. In one preferred form, the frequency of said game enhancing symbols awarding game enhancing elements of higher value appearing on said additional second reel increases as the value or amount of said bet increases.

Preferably, there is a plurality of said second reels and said predetermined symbol positions in said first reel are respectively associated with said second reels. More preferably, a first special game symbol appearing in one of said predetermined symbol positions of said first reel causes said game symbols in the associated second reel to change into another game symbol. In one preferred form, said game symbols in the associated second reel change into at least one of said special game symbol and a substitute symbol.

Preferably, said game comprises a base game and a feature game, said base game comprising said first reel and said second reels, and said electronic game controller causes an additional first reel to be displayed with said first reel and said second reels in said feature game, and wherein said predetermined symbol positions in said additional first reel are respectively associated with said predetermined positions of said first reel. More preferably, a second special game symbol appearing in one of said predetermined symbol positions of said first reel causes said additional first reel to spin. In one preferred form, the appearance of a game enhancing symbol in the predetermined symbol position of said additional first reel associated with the predetermined symbol position of said first reel displaying said second special game symbol causes the award of a game enhancing element associated with said game enhancing symbol.

Preferably, said feature game comprises a further first reel, said predetermined symbol positions in said further first reel are respectively associated with said predetermined positions of said additional first reel. More preferably, a third special game symbol appearing in one of said predetermined symbol positions of said additional first reel causes said further first reel to spin. In one preferred form, the appearance of a game enhancing symbol in the predetermined symbol position of said further first reel associated with the predetermined symbol position of said additional first reel displaying said third special game symbol causes the award of a game enhancing element associated with said game enhancing symbol. In one preferred form, said game enhancing symbol comprises a jackpot symbol and said game enhancing element comprises a jackpot prize. In a particularly preferred form, said predetermined symbol positions of said further first reel are associated with separate jackpot prizes.

Preferably, the probability of said third special symbol appearing in said in one of said predetermined symbol positions of said additional first reel depends on the value or amount of a bet made to play said base game. More preferably, the frequency of said third special symbols appearing on said additional first reel increases as the value or amount of said bet increases

Preferably, the type of game enhancing symbols available for display on said additional first reel depend on the value or amount of a bet made to play said base game. More preferably, game enhancing symbols awarding game enhancing elements of higher value become available for higher value or amounts of said bet. In one preferred form, the frequency of said game enhancing symbols awarding game enhancing elements of higher value appearing on said additional first reel increases as the value or amount of said bet increases.

Preferably, said game enhancing element modifies the result of a play of said game. More preferably, said game enhancing element comprises at least one or more of a predetermined number of free games, bonus prizes, collector symbols, a win multiplier, wild multipliers, bonus wilds, symbols that cause the award of additional free games, trigger symbols to retrigger the selected wheel or enhanced wheel, directly retriggering the selected wheel or enhanced wheel, held columns, random wild symbols, progressives, bonus credits, jackpot symbols, and one or more symbol replacements.

Preferably, a plurality of said third special symbols appears in said predetermined symbol positions of said additional first reel or additional second reel, resulting in the award of said associated game enhancing elements simultaneously.

Preferably, where there is a plurality of first reels, said first reels are organised into a sub-array having a polygonal shape. For example, said sub-array can take any one of a rectangular, square, triangular, pentagonal, octagonal or non-rectangular polygonal shape. In one preferred form, said sub-array is the industry standard 5×3 array of rows and columns. In another preferred form, said sub-array can be irregular in shape, such as for example having an uneven number of rows or columns.

Preferably, a feature game trigger event occurs in said base game to trigger said feature game. In one preferred form, said feature game trigger event comprises a random event determined by said electronic game controller at the start of play of said feature game. In another preferred form, the feature game trigger event comprises the appearance of at least one trigger symbol in said base game. In another alternative, the feature game trigger event comprises an in-game event during play of the base game.

Preferably, the player selectively starts and/or stops play of said base game array and/or said feature game array.

Preferably, the electronic gaming machine comprises a mobile electronic gaming device. More preferably, said mobile electronic gaming device comprises a handheld electronic device. In one preferred form, said handheld electronic device comprises a handheld electronic gaming device or a smart phone. Alternatively, said electronic gaming machine comprises a computer. More preferably, said computer is connected to a communication network.

According to a second aspect of the invention, there is provided a gaming method for an electronic gaming machine comprising a display and an electronic game controller, comprising:

controllably displaying game symbols on said display to play a game wherein predetermined winning combinations of randomly selected game symbols in said game award prizes to a player;

arranging said game symbols into an array of predetermined symbol positions to define a plurality of reels,

displaying said game symbols in a first of said reels so that said game symbols visually move in a linear path on said display, and

displaying said game symbols in a second of said reels so that said game symbols visually move in a non-linear path on said display.

Preferably, said second reel displaying step comprises displaying said second reel as having an arcuate or curved shape in the horizontal plane of said display such that said game symbols visually move in an arcuate or curved path in said second reel.

Preferably, said method further comprises displaying at least one game symbol in one of said first reel and said second reel that interacts with the game symbols appearing in the other of said first reel and said second reel. More preferably, said at least one game symbol comprises a special game symbol.

Preferably, said method further comprises providing a plurality of said first reels and respectively associating said predetermined symbol positions in said second reel with said first reels. More preferably, said method further comprises displaying a first special game symbol in one of said predetermined symbol positions of said second reel and changing said game symbols in the associated first reel into another game symbol in response to said display of said first special game symbol. In one preferred form, said changing step comprises changing said game symbols into at least one of said special game symbol and a substitute symbol.

Preferably, said method further comprises providing a trigger event in said first reels and causing second reel to spin in response to said trigger event. More preferably, said trigger event comprises the appearance of a trigger symbol in one of said first reels.

Preferably, said game comprises a base game and a feature game, said base game comprising said first reels and said second reel, said method further comprising displaying an additional second reel with said first reels and said second reel in said feature game, and respectively associating said predetermined symbol positions in said additional second reel with said predetermined positions of said second reel. More preferably, said method further comprises displaying a second special game symbol in one of said predetermined symbol positions of said second reel and causing said additional second reel to spin in response to said display of said second special symbol. In one preferred form, said method further comprises displaying a game enhancing symbol in the predetermined symbol position of said additional second reel associated with the predetermined symbol position of said second reel and causing the award of a game enhancing element associated with said game enhancing symbol.

Preferably, said method further comprising displaying a further second reel in said feature game and respectively associating said predetermined symbol positions in said further second reel with said predetermined positions of said additional second reel. More preferably, said method further comprises displaying a third special game symbol appearing in one of said predetermined symbol positions of said additional second reel and causing said further second reel to spin in response to said display of said third special symbol. In one preferred form, said method further comprises displaying a game enhancing symbol in the predetermined symbol position of said further second reel associated with the predetermined symbol position of said additional second reel and causing the award of a game enhancing element associated with said game enhancing symbol. In a particularly preferred form, said game enhancing symbol comprises a jackpot symbol and said game enhancing element comprises a jackpot prize.

Preferably, said method further comprises providing a plurality of said second reels, said method further comprising respectively associating said predetermined symbol positions in said first reel with said second reels. More preferably, said method further comprises displaying a first special game symbol in one of said predetermined symbol positions of said first reel and changing said game symbols in the associated second reel into another game symbol. In one preferred form, said changing step comprises changing said game symbols into at least one of said special game symbol and a substitute symbol.

Preferably, said game comprises a base game and a feature game, said base game comprising said first reel and said second reels, said method further comprising displaying an additional first reel with said first reel and said second reels in said feature game, and respectively associating said predetermined symbol positions in said additional first reel with said predetermined positions of said first reel. More preferably, said method further comprises displaying a second special game symbol in one of said predetermined symbol positions of said first reel and causing said additional first reel to spin in response to said display of said second special symbol. In one preferred form, said method further comprises displaying a game enhancing symbol in the predetermined symbol position of said additional first reel associated with the predetermined symbol position of said first reel and causing the award of a game enhancing element associated with said game enhancing symbol.

Preferably, said method further comprising displaying a further first reel in said feature game and respectively associating said predetermined symbol positions in said further first reel with said predetermined positions of said additional first reel. More preferably, said method further comprises displaying a third special game symbol in one of said predetermined symbol positions of said additional first reel and causing said further first reel to spin in response to said display of said third special symbol. In one preferred form, said method further comprises displaying a game enhancing symbol in the predetermined symbol position of said further first reel associated with the predetermined symbol position of said additional first reel displaying said third special game symbol and causing the award of a game enhancing element associated with said game enhancing symbol. In a particularly preferred form, said game enhancing symbol comprises a jackpot symbol and said game enhancing element comprises a jackpot prize.

The method also preferably has the preferred features of the first aspect of the invention stated above, where applicable.

According to a third aspect of the invention, there is provided a gaming system comprising a central processing unit configured for communication with an electronic gaming machine, wherein said gaming system is configured to perform the method of the second aspect of the invention on said electronic gaming machine.

According to a fourth aspect of the invention, there is provided a computer program configured to perform the method of the second aspect of the invention.

According to a fifth aspect of the invention, there is provided a non-transitory carrier medium carrying computer executable code that, when executed on a central processing unit configured for communication with an electronic gaming machine, causes the central processing unit to perform the method of the second aspect of the invention on said electronic gaming machine.

### BRIEF DESCRIPTION OF THE DRAWINGS

A preferred embodiment of the invention will now be described, by way of example only, with reference to the accompanying drawings in which:

FIG. 1 is a perspective view of an electronic gaming machine according to a first embodiment of the invention;

FIG. 2 is a schematic drawing of an electronic game controller for the electronic gaming machine of FIG. 1;

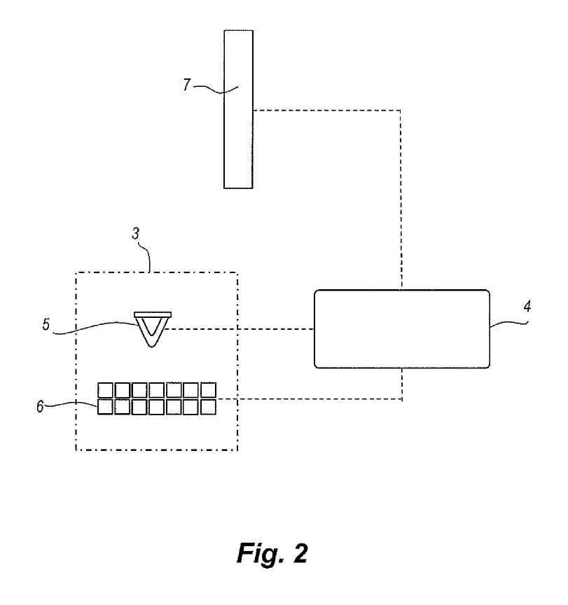

FIG. 3 is a front view of the display of the electronic gaming machine of FIG. 1 illustrating a base game,

FIG. 4 is a front view of the display of the electronic gaming machine of FIG. 1 illustrating a feature game;

FIG. 5 is a front view of the display of the electronic gaming machine of FIG. 1 illustrating a base game in accordance with another embodiment of the invention;

FIG. 6 is a front view of the display of the electronic gaming machine of FIG. 1 illustrating a feature game for the base game of FIG. 5.

### DETAILED DESCRIPTION OF THE VARIOUS EMBODIMENTS

The present invention will now be described with reference to the following examples which should be considered in all respects as illustrative and non-restrictive.

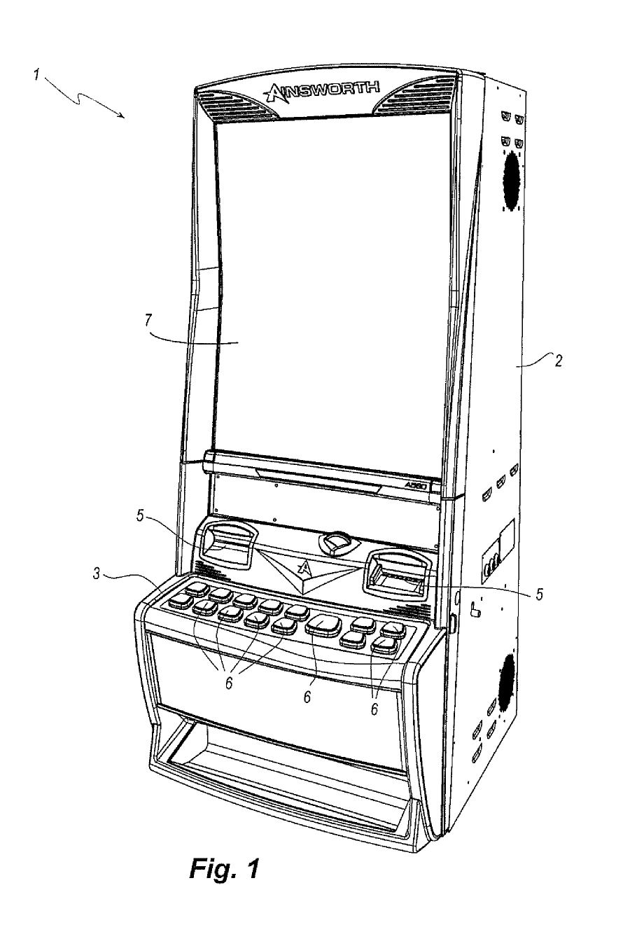

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. The electronic game controller 4 is generally in the form of a central processing unit, such as a computer, and is in electronic communication with a display 7 in the form of a video display screen, as well as various input devices on the console 3. It is also appreciated that a person skilled in the art would readily understand the location and use of the electronic game controller 4 in the electronic gaming machine 1.

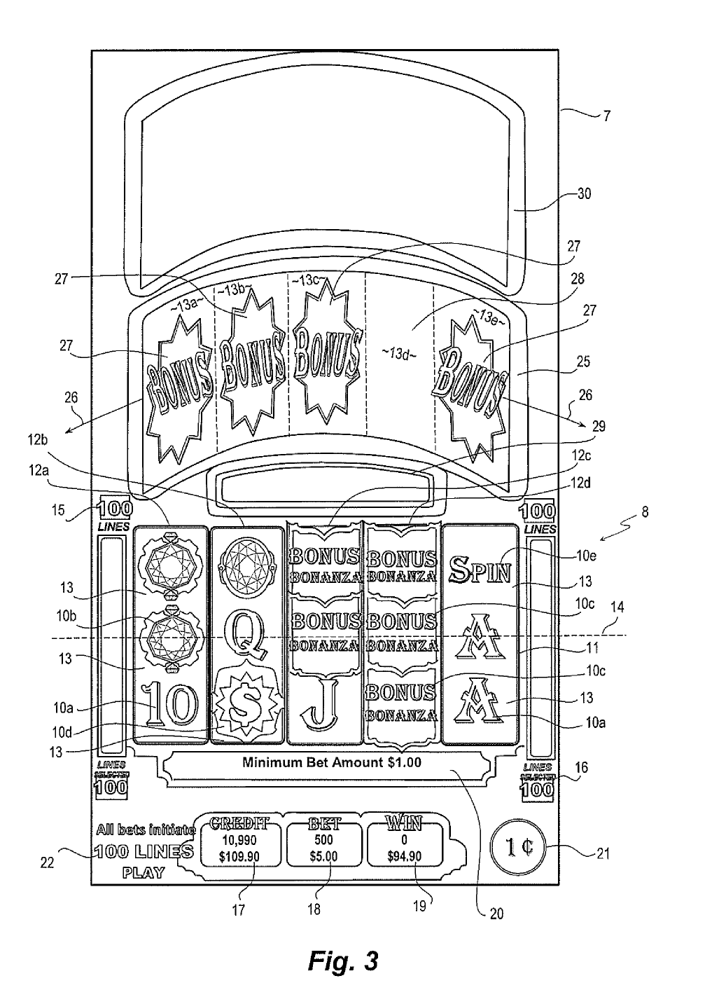

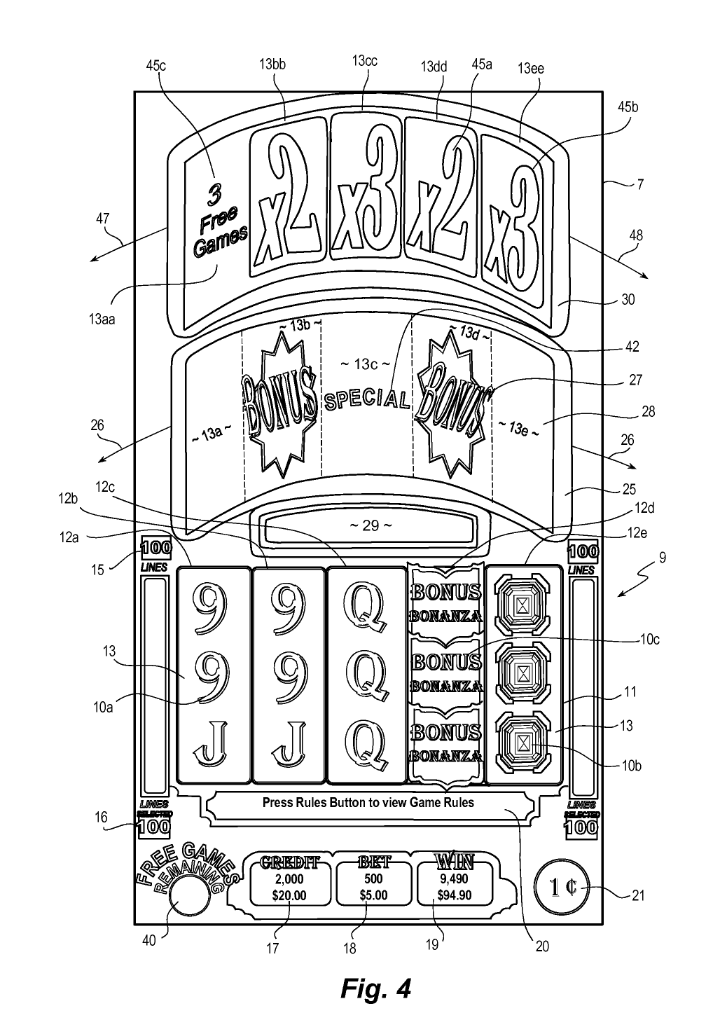

The electronic game controller 4 is programmed to provide a game in the form of a base game 8 (as best shown in FIG. 3) and a feature game 9 (as best shown in FIG. 4) on the electronic gaming machine 1 for play by a player. The base game 8 has game symbols 10 arranged into an array 11 in the form of five columns or “reels” 12, as best shown in FIG. 3. The reels 12 give the visual appearance of rotating, typically by having the game symbols 10 move in a downward linear path along the length of each reel 12. While the array 11 is arranged with five reels 12 and three rows, it will be appreciated by one skilled in the art that other types of arrays could be used, such as 3×3, 4×3, 5×5, 4×4, etc, including arrays having an irregular number of rows and/or columns.

The array 11 of the base game 8 defines predetermined symbol positions 13, in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines or other markings to define each respective area of the symbol positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, item-themed symbols 10b, substitute or wild card symbols in the form of “BONUS BONANZA” symbols 10c, a scatter symbol in the form of a $ symbol 10d and a trigger symbol in the form of a “SPIN” symbol 10e. The electronic game controller 4 randomly determines the appearance of the game symbols 10 on the array 11.

The video screen 7 also displays other standard game information including the number of pay lines available 15, the number of player-selected pay lines 16, the amount of player credits 17, the amount of the current bet wagered by the player 18, the amount of wins by the player 19, a message area 20, a current denomination button 21 indicating the currently selected base bet denomination and a second message area 22.

The array 11 has another reel 25 where game symbols 10 are displayed in symbol positions 13 and move in a non-linear path on the video display screen 7. In this embodiment, the reel 25 has an arcuate or curved shape in the horizontal plane of the video screen 7, so that the game symbols appearing on the reel 25 move along an arcuate or curve path, as shown by arrows 26 in FIG. 3. In practice, the game symbols 10 will move in one of the directions indicated by arrows 26. The game symbols in the curved reel 25 include a special game symbol in the form of a “BONUS” star symbol 27 and a “blank” 28, to show that the symbol position 13 is unoccupied. Other game symbols 10, such as playing card symbols 10a and item-based symbols 10b may also be displayed in the curved reel 25. However, the BONUS star symbol 27 and blanks 28 only appear in the curved reel 25. The BONUS star symbol 27 also acts as a substitute symbol, like the BONUS BONANZA symbol 10c. There is also a small area 29 between the curved reel 25 and the reels 12a to 12e for displaying messages, images and/or animations during game play.

The symbol positions 13 of the curved reel 25 are respectively associated with the reels 12a to 12e. In the embodiment, the symbol positions 13 of the curved reel 25 are displayed so as to be in vertical alignment with their associated reels. Hence, symbol position 13a of the curved reel 25 is associated with the first reel 12a, symbol position 13b is associated with the second reel 12b, symbol position 13b is associated with the second reel 12b, symbol position 13b is associated with the second reel 12b and symbol position 13b is associated with the second reel 12b.

A second curved reel 30 identical to the curved reel 25 is located above the curved reel, also having symbol positions 13 and is reserved for use in the feature game 9. In other preferred forms, the curved reel 30 is not shown in the base game 8 but is replaced with an image providing the name of the game comprising the base game and the feature game 9.

In the base game 8, the player initially makes a bet using vending slots 5 initiate play of the electronic gaming machine 1 to build up credit to play the base game 8 on the electronic gaming machine. For example, the player can bet or wager monetary amounts equivalent to a particular amount of credits, depending on the bet denomination selected for the base game. Also, the player can make any additional side bets or ante-bets during play of the base game once the game has commenced to access additional features in the game, such as increasing the number of winning combinations in the game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

Typically, the electronic gaming machine also has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Typically, the electronic game controller 4 will select the bet denomination with the lowest value that is available for the base game 8, which would be the 1¢ bet denomination for this embodiment. The player may change the bet denomination at any time in the base game 8 by touching the denomination button before or after the reels 12 have spun.

The electronic game controller 4 then causes the reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 9 can also be provided. If so, the gaming machine 1 enters a winning game state and awards a prize according to the displayed predetermined winning combination.

The electronic game controller 4 also determines whether the trigger SPIN symbol 10e in the reels 12. If the trigger SPIN symbol 10e appears in one of the symbol positions 13 of reels 12a to 12d, then the play of the base game 8 ends. If the trigger SPIN symbol 10e appears the fifth reel 12e, this causes the electronic game controller 4 to trigger the curved reel 25 to spin in the direction of the left arrow 26 or right arrow 26. It will be appreciated that in other embodiments, the trigger SPIN symbol 10e can appear anywhere in the reels 12a to 12e to trigger a spin of the curved reel 25.

Once the curved reel 25 stops spinning, the electronic game controller 4 checks what game symbols are displayed in the symbol positions 13a to 13e of the curved reel 25. Where a BONUS star symbol 27 appears in one of the symbol positions 13 of the curved reel 25, the electronic game controller 4 causes the game symbols 10 in the associated symbol positions 13 of the reel 12 change or transform into another game symbol. In the embodiment, the game symbols 10 in the associated reel(s) 12 change into the substitute or wild card BONUS BONANZA symbols 10c. Thus, in effect, the BONUS star symbol 27 results in the award of a game enhancing element in the form of a “held reel”, where all the game symbols in a reel are replaced by wild/substitute game symbols, thus enhancing the probability of achieving a predetermined combination. The appearance of the BONUS star symbol 27 is also accompanied by a congratulatory message, animation, sounds, images or any combination thereof, either within or originating from the area 29 to indicate the BONUS star symbol to the player.

For example, FIG. 3 illustrates the end of the spin of the curved reel 25, where four BONUS star symbols 27 have appeared in symbol positions 13a, 13b, 13c and 13e. As a result, all the game symbols 10 in the associated reels 12a, 12b, 12c and 12e will change into wild card BONUS BONANZA symbols 10c. Since three BONUS BONANZA symbols 10c have already appeared in the symbol positions 13 of the reel 12d at the end of the initial spin of the reels 12, all of the reels will display the BONUS BONANZA symbols 10c, resulting in a maximum winning combination for the player. Hence, there is an increased chance of a winning combination of game symbols appearing in the player-selected pay lines 14 on the reel 12a to 12e, thus enhancing the player's interest and excitement in the base game 8.

The electronic game controller 4 also determines whether the feature game 9 should be activated, based on a trigger event in the base game 8. In this embodiment, the trigger event is the appearance of three scatter symbols, being the $ symbol 10d. The scatter symbols need not appear on the same pay line 14, but can appear on any of the player-selected pay lines.

In response to the feature game trigger event, the electronic game controller 4 causes the feature game 9 to appear on the video screen 7, as best shown in FIG. 4 where corresponding features have been given the same reference numerals. The feature game 9 also uses the same game symbols 10 as the base game 8, as well as the same array 11, reels 12 and 25, symbol positions 13 and player-selectable pay lines 14 on the video screen 7. In the feature game 9, ten free plays or spins of the feature game are awarded to the player without having to make an additional bet or wager. It will be understood by those skilled in the art that a free spin involves a play of the game without requiring any bet to be made by the player, and that any number of free spins can be chosen for the feature game. In addition, it will be appreciated that in the art free spins are commonly referred to as “free games”. The number of free games remaining in the feature game 9 is indicated by a counter 40.

In this embodiment, the feature game 9 adds the additional curved reel 30 to the array 11 comprising the reels 12 and curved reel 25 from the base game 8. The additional curved reel 30 has symbol positions 13aa, 13bb, 13cc, 13dd and 13ee that are respectively associated with the symbol positions 13a, 13b, 13c, 13d and 13e of the curved reel 25.

Also, the additional curved reel 30 displays game enhancing symbols 45 instead of the game symbols 10 that are used in the reels 12 and curved reel 25. The game enhancing symbols 45 each confer a game enhancing element upon the player that increases the value of any prizes that have been won, alters the base or feature game beneficially for the player or awards an additional prize. In this embodiment, the game enhancing symbols 45 include an “×2” multiplier symbol 45a, an “×3” multiplier symbol 45b and a “3 Free Games” symbol 45c, as best shown in FIG. 4. Other game enhancing symbols 45 include and “×5” multiplier symbol and a “5 Free Games” symbol. In another embodiment, the game enhancing symbols 45 includes a jackpot symbol that will confer a jackpot prize.

The feature game 9 operates in a similar manner to the base game 8, where the reels 12 visibly rotate and display randomly selected game symbols 10 in each symbol position 13, as best shown in FIG. 4. Predetermined winning combinations of randomly selected game symbols 10 in the reels 12 of the feature game 9 also result in the award of prizes to the player, usually of an enhanced value compared to the prizes awarded in the base game 8.

The curved reel 25 and the BONUS star symbol 27 in the feature game 9 also act in the same way as they do in the base game 8. However, another special symbol in the form of SPECIAL symbol 42 can appear in the symbol positions 13a to 13e of the curved reel 25. When one or more SPECIAL symbols 42 appear in the curved reel 25, the electronic game controller 4 causes the additional curved reel 30 to “spin”. That is, the curved reel 30 displays game enhancing symbols 45 that move in a curved or arcuate path along the length of the curved reel, as best shown by arrow 47 in FIG. 4. The game enhancing symbols 45 can also move in the opposite direction as shown by arrow 48 in FIG. 4.

When the curved reel 30 stops spinning, the electronic game controller 4 determines which game enhancing symbols 45 appear in the symbol position(s) 13aa to 13ee associated with the symbol positions 13a to 13e in which a SPECIAL symbol 42 is displayed, and then awards the game enhancing element(s) associated with the game enhancing symbol(s) 45. For example, in FIG. 4 a SPECIAL symbol 42 has appeared in the symbol position 13c of the curved reel 25 to activate a spin of the additional curved reel 30. The ×3 multiplier symbol 45b appears in the symbol position 13cc of the curved reel 30 associated with symbol position 13c, resulting in an award of an ×3 multiplier. That is, the effect of the ×3 multiplier is to triple the value of any prizes that have been granted for winning combinations in the reels 12a to 12e that use any of the game symbols 10a that appear in the symbol positions 13 of the reel 12c associated with the symbol position 13c of the curved reel 25. The “3 Free Games” game enhancing symbol 45c would add another three free games to the counter 40. The game enhancing symbols 45c also make the symbol positions 13 of the reels 12 associated with symbol positions of the curved reel 25 displaying the SPECIAL symbol 42 display substitute BONUS BONANZA symbols 10c to further enhance the value of any winning combinations of game symbols in the reels 12.

After determining the award of any game enhancing elements via the display of the game enhancing symbols 45 in the symbol positions of the additional curved reel 30 associated with the symbol positions of the curved reel 25 displaying a SPECIAL symbol 42, the electronic game controller 4 commences another play of the feature game 9 by spinning the reels 12 in the array 11.

In other preferred forms, one or more of the BONUS star symbols 27, SPECIAL symbol 42 and the game enhancing symbols 45 can be animated to indicate their presence to the player. For example, the symbols could be accompanied by flashing lights, congratulatory sounds or move within their respective symbol positions.

While the embodiments of the invention have been described as using a change or transformation of game symbols into substitute symbols as the reward for the BONUS star symbol 27 appearing in the curved reel, it will be appreciated that a game enhancing element can be awarded instead or in conjunction with the transformation of game symbols. Likewise, the award of the multiplier and free games by the additional curved reel 30 can also be replaced or supplemented by other game enhancing elements. For example, game enhancing symbols, such as progressive symbols, symbols changing the function of a standard game symbol 10a, 10b, 10c into a substitute symbol in addition to any displayed WILD substitute symbols 10e and symbols changing the game symbols in symbol positions adjacent to the associated symbol positions, can all be used as additional or alternative game enhancing symbols (with their associated game enhancing elements).

Progressive symbols award a prize is awarded upon a certain number of progressive symbols are accumulated by the player over a number of games played on the gaming machine. Other examples of game enhancing elements include:
i) 15 Free Games;
ii) 10 Free Games;
iii) 8 Free Games;
iv) Bonus Prize of 5× bet (the total amount of the bet or credits bet per pay line);
v) Bonus Prize of 10× bet (the total amount of the bet or credits bet per pay line);
vi) Bonus Prize of 25× bet (the total amount of the bet or credits bet per pay line);
vii) Jackpot symbols for awarding monetary jackpots, including progressive jackpots, associated with the base game, feature game and/or the electronic gaming machine 1 independently of the game being played;
viii) Fixed monetary prizes awarded in addition to the prize won for the winning combination;
ix) Multiplier symbols that apply multipliers like ×3, ×5 and ×10 to prizes awarded for specific combinations likes five of kind and/or to the total amount of the bet or credits bet per pay line;
x) All royal card symbols change to substitute symbols on reels 2, 3 and 4;
xi) All picture symbols 10b change to wilds on reels 2, 3 and 4, and
xii) All symbols change to wild symbols on reels 1 and 5.

These game enhancing symbols do not modify the function or value of the game symbols 10 that appear on the arrays 11, 50, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another preferred form, the game enhancing symbols may indicate the duration in which its game enhancing element is applied, such as a predetermined number of spins or a predetermined time period.

In other preferred forms, the game enhancing symbols include “collector”-type game enhancing symbols which award points or tokens. The collection of points or tokens during the base game 8 and/or feature game 9 leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

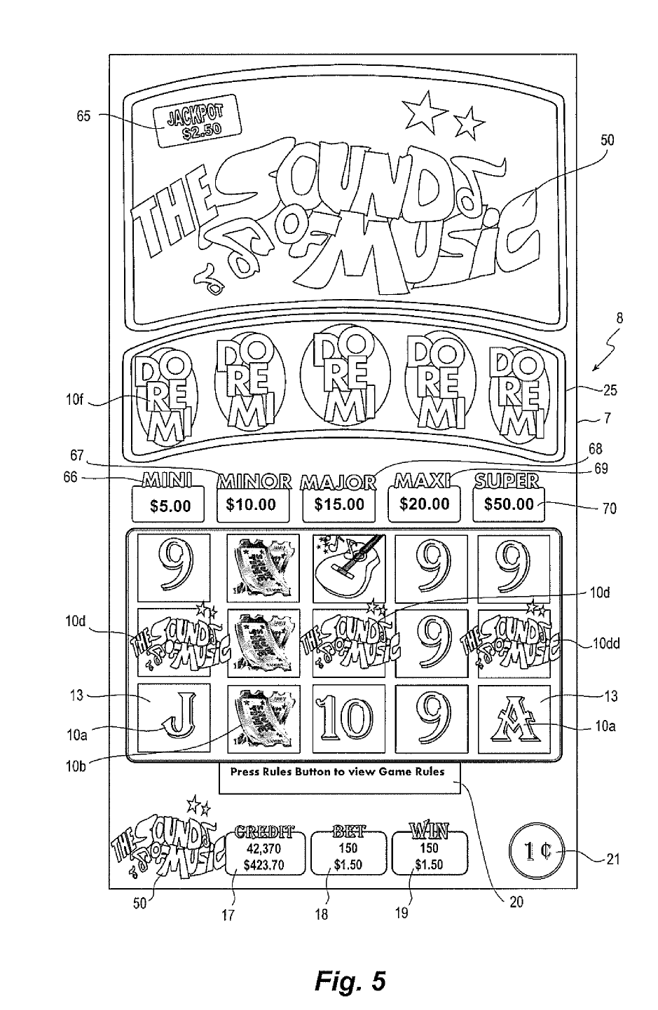

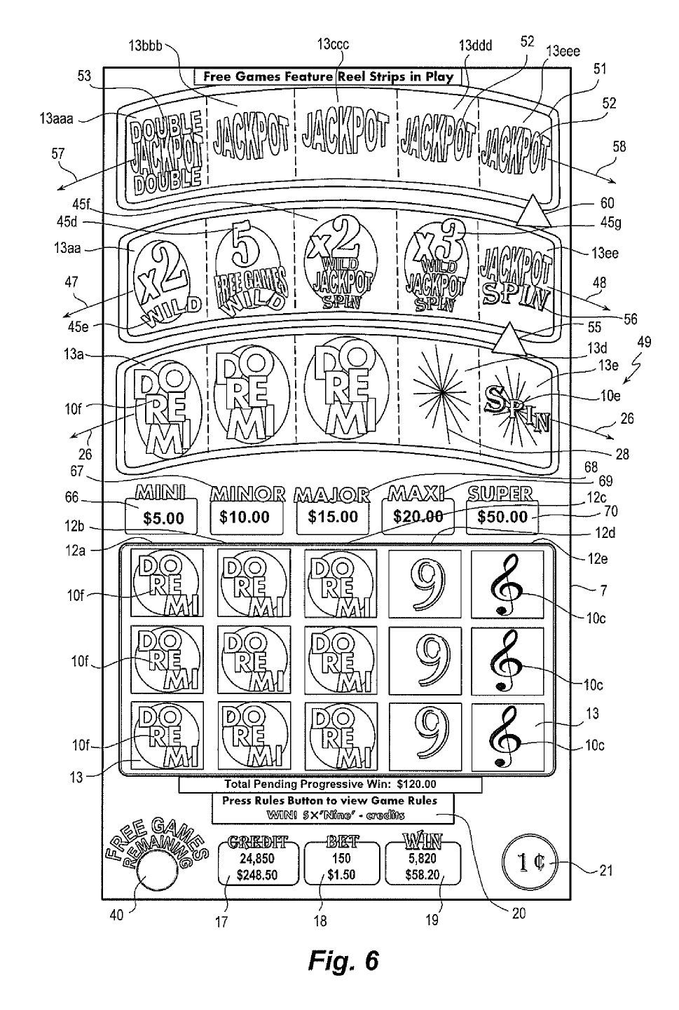

Referring to FIGS. 5 and 6, another embodiment of the invention is shown where corresponding features have been given the same reference numerals. In this embodiment, the base game 8 and feature game 49 has been thematically changed from the “Bonus Bonanza” game to a “Sound of Music” game (as indicated by the title 50), but operate in substantially the same way. The base game 8 only has the curved reel 25 while the feature game 49 has the curved reels 25 and 30. The main difference between this embodiment and the previous embodiment is that there is a third curved reel in the form of a jackpot reel 51 in the feature game 49. The jackpot reel 51 displays jackpot symbols 52 and double jackpot symbols 53, as best shown in FIG. 6.

The Sound of Music base game 8 has similar game symbols 10 as the Bonus Bonanza game, such as playing card symbols 10a, item-themed symbols 10b, wild card or substitute symbols, scatter symbols in the form of the “SOUND OF MUSIC” logo symbol 10d and a trigger symbol in the form of a “SPIN” symbol 10e. There are two types of wild card symbols, being a treble clef symbol 10c and a DO-RE-MI wildcard symbol 10f. The DO-RE-MI wild card symbol 10f confers prizes of greater value when one or more of the DO-RE-MI symbols 10f are used in a winning combination of game symbols displayed on the reels 12 compared to the prizes awarded for winning combinations of game symbols displayed on the reels 12 using one or more treble clef wild card symbols 10c.

The base game 8 works in substantially the same way as the embodiment described in FIGS. 3 and 4, where the SPIN symbol 10e appearing in the fifth reel 12e causes the curved reel 25 to spin in a non-linear path as indicated by arrow 26. Similar to the description of the embodiment of FIGS. 3 and 4, the curved reel 25 may show either the DO-RE-MI wild card symbol 10f or a blank 28 where the symbol position 13d is shown as being empty or unoccupied. The appearance of a DO-RE-MI wild card symbol 10f on the curved reel 25 results in the associated symbol positions 13 in the reels 12a to 12e to change into DO-RE-MI symbols 10f, thus increasing the probability of a winning combination of game symbols 10 appearing on the array 11.

In the feature game 49 shown in FIG. 6, the additional curved reel 30 functions in substantially the same way as described in relation to the embodiment of FIGS. 3 and 4. That is, a special symbol (in this case, the SPIN symbol 10e) appearing in any of the symbol positions 13 of the curved reel 25 causes the additional curved reel 30 to spin in a non-linear path (in either direction indicated by arrows 47 and 48) and a pointer 55 appears above the symbol position 23 in which the SPIN symbol 10e appeared to indicate which symbol position 13 will display the game enhancing symbol 45 conferred by the additional curved reel 30

The game enhancing symbols 45 in the feature game 49 that are shown in FIG. 6 comprise a “5 Free Games Wild” symbol 45d, an “×2 wild” multiplier symbol 45e, a combined “×2 wild JACKPOT SPIN” multiplier symbol 45f, an “×3 wild JACKPOT SPIN” multiplier symbol 45g and a “JACKPOT SPIN” symbol 56. Other game enhancing symbols in the feature game 49 but not shown in FIG. 6 comprise a “3 Free Games” symbol, an “×3 wild” multiplier symbol, an “×5 wild” multiplier symbol and an “×5 wild JACKPOT SPIN” multiplier symbol.

The 3 and 5 Free Games game enhancing symbols 45d award additional free spins in the feature game 49 and also change or replace the game symbols 10 appearing in the associated symbol positions 13 in the array 11 with treble clef wild card symbols 10c. The ×2, ×3 and ×5 wild multiplier symbols 45e also change the game symbols 10 in the associated symbol positions 13 in array 11 to treble clef wild card symbols 10c, but further increase the value of any prizes awarded for winning combinations of game symbols that use any of the treble clef symbols by the numerical value associated with the wild multiplier symbol. For example, the ×2 wild multiplier symbol multiplies the value of the prize by 2 (i.e. doubling), the ×3 wild multiplier symbol multiplies the value of the prize by 3 (i.e. tripling) and the ×5 wild multiplier symbol multiplies the value of the prize by 5. The JACKPOT SPIN symbol 56 triggers or activates the third curved jackpot reel 51 and also changes the game symbols in the associated symbol positions 13 into treble clef symbols 10c. The ×2 wild, ×3 wild and ×5 wild JACKPOT SPIN symbols 45f, 45g have the same function as the ×2 wild, ×3 wild and ×5 wild symbols, but also activates the curved jackpot reel 51. Thus, the wild JACKPOT SPIN symbols are more desirable to the player as they perform three functions: change the associated symbol positions 13 in the reels 12 to treble clef substitute symbols 10c, multiply the prize of any winning combinations using the treble clef symbols and activate the jackpot reel 51.

When the curved jackpot reel 51 is activated by the appearance of a JACKPOT SPIN symbol 56 or a wild multiplier JACKPOT SPIN symbol (such as the ×3 Wild JACKPOT SPIN symbol 45g) in the symbol position 13 that is indicated by the pointer 55, it spins in a non-linear path either in an arcuate direction to the left (indicated by arrow 57) or the right (indicated by arrow 58). A pointer 60 also appears to indicate the symbol position 13 of the jackpot reel 51 in which the JACKPOT symbol 52 or DOUBLE JACKPOT symbol 53 must appear to award the jackpot prize to the player. The symbol positions 13aaa, 13bbb, 13ccc, 13ddd, 13eee are individually associated with five separate jackpots that can be won by the player. These separate jackpots are in the form of a mini jackpot 66, a minor jackpot 67, major jackpot 68, a maxi jackpot 69 and a super jackpot 70. The location of the initial SPIN symbol 10e in the curved reel 25 determines which of the jackpots can be won on the jackpot reel 51, since the location of the JACKPOT and DOUBLE JACKPOT symbols 52, 53 are determined by the location of JACKPOT SPIN symbol 56 or a wild multiplier JACKPOT SPIN symbol 45f, 45g in the curved reel 30, which are in turn determined by the location of the SPIN symbol 10e in the curved reel 25. Thus, all the symbols for activating each curved reel 25, 30, 51 are in alignment with each other.

It will be appreciated that in other embodiments, it is not necessary for this alignment to occur and the electronic game controller 4 may randomly select the location the symbol position 13 in each curved reel 25, 30, 51 that is used to award the game enhancing element or jackpot. For example, the SPIN symbol 10e may appear in reel 12c to activate the curved reel 25 and a symbol position 13a to 13e is randomly selected to display a pointer, such as symbol position 13d. Likewise, a SPIN symbol 10e may appear in symbol position 13d of the curved reel 25 and a symbol position 13aa to 13ee of the curved reel 30 is randomly selected to display the pointer 55, such as symbol position 13bb. A JACKPOT SPIN symbol may appear in symbol position 13bb and a symbol position 13aaa to 13eee of the jackpot reel 51 is randomly selected to display the pointer 60, such as symbol position 13ccc.

In the play of the feature game 49 shown in FIG. 6, the curved reel 25 has been activated by a SPIN symbol 10e appearing in the fifth reel 12e and ends in the display of DO-RE-MI substitute symbols 10f appearing in symbol positions 13a to 13c and a SPIN symbol 10e appearing in symbol position 13e of the curved reel 25. The DO-RE-MI symbols 10f cause the game symbols 10 in the associated symbol positions 13 of reels 12a to 12c to change into DO-RE-MI symbols, thus increasing the chances of a winning combination of game symbols 10 on the array 11. The DO-RE-MI symbols 10f also increase the value of the prize relative to a standard winning combination or a winning combination using treble clef symbols 10c. The SPIN symbol 10e causes the curved reel 30 to spin and the pointer 55 indicates that the symbol in symbol position 13ee will award the game enhancing element. That symbol is a JACKPOT SPIN symbol 56 that causes the game symbols 10 in the associated symbol positions 13 of reel 12e to change into treble clef symbols 10c, further enhancing the chances of a winning combination of game symbols 10 on the array 11. The JACKPOT SPIN symbol 56 also causes the jackpot reel 51 to spin and end with the pointer 60 indicating that a JACKPOT symbol 52 has been awarded. Hence, the player receives the super jackpot 70 of $50 since the symbol position 13eee is associated with this jackpot. If the DOUBLE JACKPOT symbol 53 had appeared in symbol position 13eee, then a jackpot amount is awarded. Where the jackpots 66 to 70 are progressive jackpots, the double jackpot award would involve paying the current amount of the jackpot displayed on the jackpot meter (i.e. the start-up value of the jackpot and any incremental value or amounts added since the last time the jackpot was awarded) and then also paying the start-up value of the jackpot. In other embodiments, such as where the jackpot amount is fixed, the jackpot amount is simply doubled and in the example illustrated in FIG. 6, the player would have received $100.

In this embodiment, the probability of the JACKPOT SPIN symbol 56 and the wild multiplier JACKPOT SPIN symbols 45f, 45g appearing in the curved reel 30 is dependent upon the amount that is bet on the base game 8. Higher value bets in the base game 8 results in an increased probability JACKPOT SPIN symbol 56 and the wild multiplier JACKPOT SPIN symbols 45f, 45g appearing in the curved reel 30. Also, higher value bets will increase access to higher value wild multiplier JACKPOT SPIN symbols. For example, a base bet may only result in the ×2 wild JACKPOT SPIN symbol 45f being available on the reel strip for the curved reel 30, and not the ×3 or ×5 wild JACKPOT SPIN symbols. Similarly, a lower value bet may only have one JACKPOT SPIN symbol 56 available on the reel strip for the curved reel 30, whereas a higher value bet may have two or progressively more JACKPOT SPIN symbols 56 be available on the reel strip for the curved reel 30.

In this embodiment, the base game 8 also has a separate jackpot in the form of a mystery jackpot 65 displayed in an upper part of the video display screen 7, although in other embodiments, the mystery jackpot is displayed on a separate display screen. In a mystery jackpot, none of the game symbols 10 in the game trigger the jackpot; hence the triggering event is a “mystery”. By way of comparison, a standard jackpot is typically symbol driven in that a particular combination of symbols must occur in the game to trigger the standard jackpot. The mystery jackpot is only part of the base game 8 and is not available in the feature game 49.

In other preferred embodiments, the jackpot prize can be shared with any other games offered on the electronic gaming machine (as in multi-game gaming machines) or games offered on separate electronic gaming machines. In one preferred form, the jackpot prize comprises a mystery jackpot.

Where the game enhancing element comprises the award of a jackpot prize, it can take the form of a grand progressive jackpot confined to the electronic gaming machine 1. However, in another preferred form, the grand progressive jackpot is configured to be part of a wide area or in-house link progressive jackpot. In other words, the grand progressive jackpot can be awarded on a group of networked gaming machines in a specified area or a group of specified electronic gaming machines that are linked together for jackpot purposes.

Furthermore, the embodiments of the invention have been described as providing a standard 5×3 set of reels 12 with the curved reel 25 for the base game 8. However, it will be appreciated that in other embodiments, the size and shape of the reels 12. For example, the array 11 could take any number of different shapes, such as triangular, circular, square, hexagonal, hemi-spherical or other polygonal shapes. Alternatively, the arrays 11, 50 could have an uneven number of rows or columns. For example, the reels 12a, 12b could have three rows, but the reels 12c to 12e could have four rows.

While the preferred embodiment of the invention has been described in relation to both a base game 8 and a feature game 9, those skilled in the art will appreciate that the use of the curved reels 25, additional curved reel 30, their respective association with the symbol positions 13 in the reels 12 and symbol positions 13a to 13e of the curved reel and the awarding of game enhancing elements can readily be applied to the base game alone or a feature game alone.

In a further embodiment, the association of the symbol positions between the reels 12 and the curved reels 25, 30 need not be based on a vertical alignment of the associated symbol positions, but use another relationship, such as being diagonally aligned or associated by using a common colour background for the associate symbol positions.

In another preferred form, there is a plurality of curved reels that act like the reels 12 and a single “linear’ reel that acts like the curved reel 25. Likewise, in this preferred form the additional curved reel 30 is replaced with a linear reel. However, it will be appreciated that any combination of linear and curved reels can be used for the invention.

In a further preferred form, the electronic game controller 4 randomly determines whether to trigger or activate the curved reel 25 to spin after each play of the base game 8 without requiring a SPIN symbol 10e to appear in the fifth reel 12e. In another variation, the electronic game controller 4 generates an internal trigger event, such as randomly generating a number between 1 and 10, and activating the curved reel 25 if the randomly generated number is in the range of 1 to 4. In an alternative preferred form, the electronic game controller 4 causes the curved reel 25 to spin automatically after each play of the base game 8, without requiring a SPIN symbol 10e to appear in the fifth reel 12e or any other trigger event. All these ways of triggering the curved reel 25 may also be applied to the additional curved reel 30 and jackpot reel 51.

The invention is also not limited to curved or arcuate reels, but can include other non-linear shaped reels and non-linear paths in an otherwise standard shaped reel. For example, the reels can have a zig-zag shape or take the shape of alphabet letters, where the symbol positions make up the letter. In another example, the reel may be shaped as a horizontal row, but the game symbols move in a non-linear path, such as circular, zig-zag or sinuous path across the row.

Also, in a further preferred form, the player can selectively stop spinning of the reels 12, either individually or collectively, to increase player interaction and provide the player with an opportunity to guess when a BONUS star symbol 27 or SPECIAL symbol 42 may appear in the curved reel 25, or when a JACKPOT SPIN symbol 56 or a wild multiplier JACKPOT SPIN symbol 45f, 45g may appear on the curved reel 30. Furthermore, the player can start spinning of the reels 12, either individually or collectively, to further enhance player interaction.

In other preferred forms, the base game 8 and feature game 9, 49 need not be displayed on a single video screen 7. Instead, they may be displayed on separate video screens, with the reels 12 11 appearing in a lower video screen and curved reels 25 and 30 appearing on both the lower video screen and an upper video screen.

In another preferred form, the video screen 7 is a touch screen for use in addition to the player-actuatable buttons 5 so as to enable the player to select various features, such as making monetary bets for the base game, initiating play of the base and feature games played and responding to any messages or requests issued on the electronic gaming machine 1 by the electronic game controller 4. In this case, the player may control when the reels 12 start spinning and stop spinning by simply touching the reels 12.

In yet another embodiment, a separate trigger event in the feature game 9, 49 results in additional free spins or plays of the feature game 9, 49 being awarded to the player. The separate trigger events can be combinations of existing game symbols 10 or new trigger symbols exclusive to the feature games 9, 49.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like smart phones and tablets) and other electronic devices capable of displaying a game. In the case of a mobile electronic device, in one arrangement it may permit the player to make bets using “virtual” credits that represent a monetary value, but does not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels 12, 25, 30 and the feature of providing multiple curved reels and only a single linear reel 12 can be combined into a single electronic gaming machine. Similar combinations of two or more features from the above described embodiments or preferred forms of the invention can be readily made by one skilled in the art.

By providing a set of reels with one reel having game symbols moving along a non-linear path and another reel having game symbols moving in a linear path, the invention introduces a variety in game play and game mechanics for a player, thus increasing the player's excitement and retaining his or her interest in playing the same electronic gaming machine. Also, by further providing an association between the reel having a non-linear path and the reel with the linear path, the invention in its preferred embodiments further increases the player's interest and participation in the electronic gaming machine as the player sees a direct connection between the reels and the increased chance of obtaining a winning combination, winning additional prizes or increasing the value of existing prizes. The invention also adds greater value to a player in terms of the probability of winning a prize and providing greater variety in game play, especially compared to a conventional electronic gaming machine that only has one set of reels and a single feature game. This value to the player is increased in the preferred embodiments of the invention by extending play of the reel with a non-linear path to the feature game and adding further reel(s) with a non-linear path that is also associated with the reel having a linear path. All these advantages of the invention result in the player being more likely to retain interest in continuing to play the same electronic gaming machine due to the variation in game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying a game, wherein said game comprises said game symbols arranged into an array of predetermined symbol positions to define a plurality of reels and where predetermined winning combinations of randomly selected game symbols in said game award prizes to a player, and
an electronic game controller for controlling the display of game symbols for said game on said display,
wherein said electronic game controller causes said game symbols in a first of said reels to visually move in a linear path on said display and said game symbols in a second of said reels to visually move in a non-linear path on said display.

2. The electronic gaming machine of claim 1, wherein said electronic game controller causes said second reel to be displayed as having an arcuate or curved shape in the horizontal plane of said display so that said game symbols visually move in an arcuate or curved path in said second reel.

3. The electronic gaming machine of claim 1, wherein at least one game symbol appearing in one of said first reel and said second reel interacts with the game symbols appearing in the other of said first reel and said second reel.

4. The electronic gaming machine of claim 3, wherein said at least one game symbol comprises a special game symbol.

5. The electronic gaming machine of claim 1, wherein there is a plurality of said first reels and said predetermined symbol positions in said second reel are respectively associated with said first reels.

6. The electronic gaming machine of claim 5, wherein a first special game symbol appearing in one of said predetermined symbol positions of said second reel causes said game symbols in the associated first reel to change into another game symbol.

7. The electronic gaming machine of claim 5, wherein said game symbols in the associated first reel to change into at least one of said special game symbol and a substitute symbol.

8. The electronic gaming machine of claim 5, wherein said electronic game controller causes second reel to spin in response to a trigger event in said first reels.

9. The electronic gaming machine of claim 8, wherein said trigger event comprises the appearance of a trigger symbol in one of said first reels.

10. The electronic gaming machine of claim 5, wherein said game comprises a base game and a feature game, said base game comprising said first reels and said second reel, and said electronic game controller causes said an additional second reel to be displayed with said first reels and said second reel in said feature game, and wherein said predetermined symbol positions in said additional second reel are respectively associated with said predetermined positions of said second reel.

11. The electronic gaming machine of claim 10, wherein a second special game symbol appearing in one of said predetermined symbol positions of said second reel causes said additional second reel to spin.

12. The electronic gaming machine of claim 11, wherein the appearance of a game enhancing symbol in the predetermined symbol position of said additional second reel associated with the predetermined symbol position of said second reel displaying said second special game symbol causes the award of a game enhancing element associated with said game enhancing symbol.

13. The electronic gaming machine of claim 10, wherein said feature game comprises a further second reel, said predetermined symbol positions in said further second reel are respectively associated with said predetermined positions of said additional second reel.

14. The electronic gaming machine of claim 13, wherein a third special game symbol appearing in one of said predetermined symbol positions of said additional second reel causes said further second reel to spin and the appearance of a game enhancing symbol in the predetermined symbol position of said further second reel associated with the predetermined symbol position of said additional second reel displaying said third special game symbol causes the award of a game enhancing element associated with said game enhancing symbol.

15. The electronic gaming machine of claim 1, wherein there is a plurality of said second reels and said predetermined symbol positions in said first reel are respectively associated with said second reels.

16. The electronic gaming machine of claim 15, wherein a first special game symbol appearing in one of said predetermined symbol positions of said first reel causes said game symbols in the associated second reel to change into another game symbol.

17. The electronic gaming machine of claim 16, wherein said game symbols in the associated second reel to change into at least one of said special game symbol and a substitute symbol.

18. The electronic gaming machine of claim 15, wherein said game comprises a base game and a feature game, said base game comprising said first reel and said second reels, and said electronic game controller causes said an additional first reel to be displayed with said first reel and said second reels in said feature game, and wherein said predetermined symbol positions in said additional first reel are respectively associated with said predetermined positions of said first reel.

19. The electronic gaming machine of claim 18, wherein a second special game symbol appearing in one of said predetermined symbol positions of said first reel causes said additional first reel to spin.

20. The electronic gaming machine of claim 19, wherein the appearance of a game enhancing symbol in the predetermined symbol position of said additional first reel associated with the predetermined symbol position of said first reel displaying said second special game symbol causes the award of a game enhancing element associated with said game enhancing symbol.

21. The electronic gaming machine of claim 18, wherein said feature game comprises a further first reel, said predetermined symbol positions in said further first reel are respectively associated with said predetermined positions of said additional first reel.

22. The electronic gaming machine of claim 21, wherein a third special game symbol appearing in one of said predetermined symbol positions of said additional first reel causes said further first reel to spin, and the appearance of a game enhancing symbol in the predetermined symbol position of said further first reel associated with the predetermined symbol position of said additional first reel displaying said third special game symbol causes the award of a game enhancing element associated with said game enhancing symbol.

23. A gaming method for an electronic gaming machine comprising a display and an electronic game controller, comprising:
controllably displaying game symbols on said display to play a game wherein predetermined winning combinations of randomly selected game symbols in said game award prizes to a player;
arranging said game symbols into an array of predetermined symbol positions to define a plurality of reels,
displaying said game symbols in a first of said reels so that said game symbols visually move in a linear path on said display, and
displaying said game symbols in a second of said reels so that said game symbols visually move in a non-linear path on said display.

24. The method of claim 23, wherein said second reel displaying step comprises displaying said second reel as having an arcuate or curved shape in the horizontal plane of said display such that said game symbols visually move in an arcuate or curved path in said second reel.

25. The method of claim 23, further comprising displaying at least one game symbol in one of said first reel and said second reel that interacts with the game symbols appearing in the other of said first reel and said second reel.

26. The method of claim 23, further comprising providing a plurality of said first reels and respectively associating said predetermined symbol positions in said second reel with said first reels.

27. The method of claim 26, further comprising displaying a first special game symbol in one of said predetermined symbol positions of said second reel and changing said game symbols in the associated first reel into another game symbol in response to said display of said first special game symbol.

28. The method of claim 23, wherein said game comprises a base game and a feature game, said base game comprising said first reels and said second reel, said method further comprising:
displaying an additional second reel with said first reels and said second reel in said feature game;
respectively associating said predetermined symbol positions in said additional second reel with said predetermined positions of said second reel;
displaying a second special game symbol in one of said predetermined symbol positions of said second reel;
causing said additional second reel to spin in response to said display of said second special symbol, and displaying a game enhancing symbol in the predetermined symbol position of said additional second reel associated with the predetermined symbol position of said second reel and causing the award of a game enhancing element associated with said game enhancing symbol.

29. The method of claim 28, further comprising:
displaying a further second reel in said feature game;
respectively associating said predetermined symbol positions in said further second reel with said predetermined positions of said additional second reel;
displaying a third special game symbol appearing in one of said predetermined symbol positions of said additional second reel;
causing said further second reel to spin in response to said display of said third special symbol, and
displaying a game enhancing symbol in the predetermined symbol position of said further second reel associated with the predetermined symbol position of said additional second reel and causing the award of a game enhancing element associated with said game enhancing symbol.

30. The method of claim 23, further comprising providing a plurality of said second reels and respectively associating said predetermined symbol positions in said first reel with said second reels.

31. The method of claim 30, further comprising displaying a first special game symbol in one of said predetermined symbol positions of said first reel and changing said game symbols in the associated second reel into another game symbol.

32. The method of claim 30, wherein said game comprises a base game and a feature game, said base game comprising said first reel and said second reels, said method further comprising:
displaying an additional first reel with said first reel and said second reels in said feature game;
respectively associating said predetermined symbol positions in said additional first reel with said predetermined positions of said first reel;
displaying a second special game symbol in one of said predetermined symbol positions of said first reel;
causing said additional first reel to spin in response to said display of said second special symbol, and
displaying a game enhancing symbol in the predetermined symbol position of said additional first reel associated with the predetermined symbol position of said first reel and causing the award of a game enhancing element associated with said game enhancing symbol.

33. The method of claim 32, further comprising:
displaying a further first reel in said feature game;
respectively associating said predetermined symbol positions in said further first reel with said predetermined positions of said additional first reel;
displaying a third special game symbol appearing in one of said predetermined symbol positions of said additional first reel;
causing said further first reel to spin in response to said display of said third special symbol, and
displaying a game enhancing symbol in the predetermined symbol position of said further first reel associated with the predetermined symbol position of said additional first reel and causing the award of a game enhancing element associated with said game enhancing symbol.

34. A computer system comprising a central processing unit configured for communication with an electronic gaming machine, wherein said computer system is configured to perform the method of claim 23.

35. A non-transitory carrier medium carrying computer executable code that, when executed on a central processing unit configured for communication with an electronic gaming machine, causes said central processing unit to perform the method of claim 23.
